(19) United States
(12) Patent Application Publication
(10) Pub. No.: US 2003/0004791 A1
(43) Pub. Date: Jan. 2, 2003

(54) Virtual exposition system

(76) Inventor: Kazuo Kojima, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/148,688

(22) PCT Filed: Nov. 30, 2000
(86) PCT No.: PCT/JP00/08479

(30) Foreign Application Priority Data
Dec. 3, 1999 (JP) H11-345302

(51) Int. Cl. G06F 17/60

(52) U.S. Cl. 705/12

(57) ABSTRACT

The present invention provides a system for (1) transmitting, from a Web server to a user's personal computer that is connected to the Internet, Web pages for a virtual exhibition to be displayed on said personal computer and (2) easily collecting specific product information through simple operations performed by the user. Exhibit data provided by companies participating in the exhibition is edited in a uniform format, classified into a plurality of categories by types of business, further classified by specific product and technology themes, and stored in a database, thereby facilitating access of specific product information.

### TECHNICAL FIELD

The present invention relates to a system for transmitting Web pages for a virtual exhibition space from a Web server to a user terminal such as a personal computer connected to the Internet, and for displaying the Web pages on said personal computer. This display screen enables users to collect specific product information with ease.

### BACKGROUND ART

The following is a description of the conventional method for by which a consumer collects data concerning specific products. The specific product in this example is studless tires. When collecting data regarding the features and prices of studless tires of various brands and various manufacturers, a user of the conventional method begins by looking for exhibitions held exclusively on studless tires. Ordinarily, however, there are no exhibitions held only on studless tires.

Hence, the user of the conventional system must then attend large-scale exhibitions, such as motor shows. However, in this case, the user must be available during the limited time period of the exhibition and moreover must walk around a large convention center, browsing the display booths of each company.

Alternatively, an individual can search for the home pages of companies on the Internet. In this case, the user inputs keywords such as “studless tire” or the manufacturer's name and selects from among various addresses found in the search. Next, the user displays the Website of, for example, Company A and follows links on that Website to various pages for studless tires. The user can download and save the necessary product data.

Next, the user must view the Website of Company B and repeat the same operations performed for Company A.

The user must repeat this procedure for each company and edit the data format for each company in order to compare data. When necessary, the user must order material, such as catalogs of merchandise, to be sent by mail.

In view of the foregoing, it is an object of the present invention to provide a system that is (1) able to transmit Web pages for a virtual exhibition from a Web server to a user's personal computer that is connected to the Internet, with said Web pages to be displayed on said personal computer, and (2) able to easily collect product information through simple operations performed by the user. Here the user accesses the display on the user's personal computer and uses a database in which product information is presorted according to business type and further sorted by specific products for each company, enabling the user to take part in a virtual exhibition held exclusively for a single specific product, such as studless tires, and thereby to compare the products of various company.

### DISCLOSURE OF THE INVENTION

These objects will be attained by the present invention's virtual exhibition system, which is (1) capable of transmitting a Web page for a virtual exhibition from a Web server to a user's terminal, such as a personal computer, that is connected to the Internet, and (2) capable of displaying the Web page on the user's terminal, enabling the user to collect product information from the displayed Web page. The system comprises (1) a virtual-exhibition database that is provided with a folder for each of a plurality of categories denoting types of businesses, and that is used to classify companies' exhibited product data that is entered in a virtual exhibition, and that stores files with thematic names of the virtual exhibitions that denote a category of products or their technologies and that identify product types that further classify the exhibited product data in each category; (2) a product-information database for storing a large volume of product data, such as videos and images, released by companies for such exhibitions; (3) virtual exhibiting means for (a) reading data from the virtual-exhibition database, (b) displaying a screen corresponding to a user's selection when the user selects, on the user's terminal, either one of the categories or one of the thematic names of the virtual exhibitions from the Web page, (c) for displaying booths in a virtual exhibition comprising companies that entered products under the thematic name selected by the user, and (d) displaying exhibit data edited in a uniform format for a company selected by the user; and (4) product-information displaying means for reading data from the product-information database and for displaying a screen of product information, including video and images, when the user requests more-detailed information for a product after selecting a booth in the virtual exhibition.

Further, the virtual exhibition system recited in claim 1 further comprises a virtual-negotiation-room means for enabling a user and a company participating in the exhibition to conduct a highly confidential discussion over an Internet communication line about a product exhibited by the company when the user “visits” (i.e., selects) the company's booth in the virtual exhibition and selects “Negotiation Room” from the screen displayed on the user's terminal.

Further, the virtual-negotiation-room means transmits a negotiation request to a representative of the company via the Web page when the user selects “Negotiation Room;” allows negotiations to commence between the user and the representative after the representative sends to the user a conversation application that includes a built-in encryption key and logs into a private-conversation Web page at a preset date and time and the user receives the reply from the representative and also logs into the private-conversation Web page at the preset date and time using the conversation application, providing both the representative and the user input-correct passwords when the system prompts for password input; and automatically deletes all data related to the conversation application from the system after receiving a signal indicating the conversation has ended.

Further, the user can participate in a workshop, an open forum, or the like via a Web page that is displayed after the user first selects “Participate in a Convention” in the initial Web page displayed on the user's terminal and then selects either “Virtual Seminar” or “Virtual Forum.”

Further, the user can participate via a Web page in a virtual hall involving a drawing or sales promotion by first selecting “Event Halls” in the initial Web page displayed on the user's terminal and then selecting a hall.

### BRIEF DESCRIPTION OF THE DRAWINGS

In the drawings:

FIG. 1 is a block diagram showing the virtual exhibition system of the present invention;

FIG. 2 is a block diagram showing the virtual exhibition system of the present invention;

FIG. 3 is a screen image of the home page for virtual exhibitions;

FIG. 4 is a screen image of a Web page listing categories for virtual exhibitions;

FIG. 5 is a screen image of a Web page listing specific products and technologies for virtual exhibitions;

FIG. 6 is a screen image of a Web page showing virtual booths for specific products and technologies in a virtual exhibition; and

FIG. 7 is a screen image showing a private-conversation Web page used as a virtual negotiation room.

### BEST MODE FOR CARRYING OUT THE INVENTION

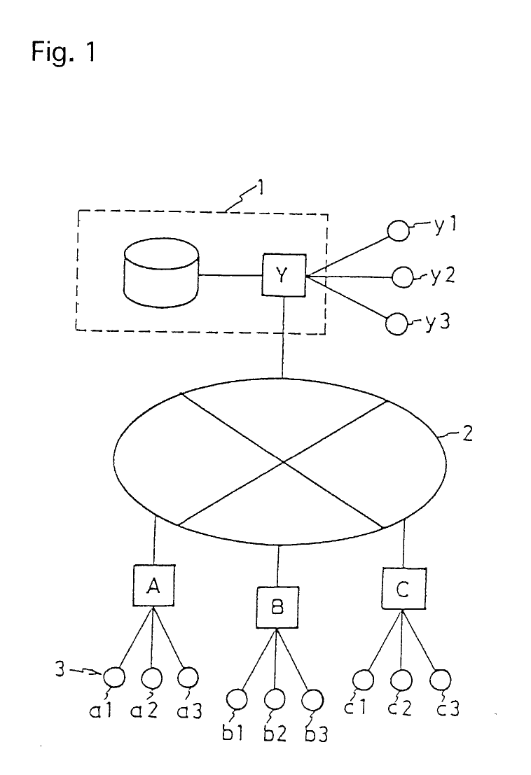

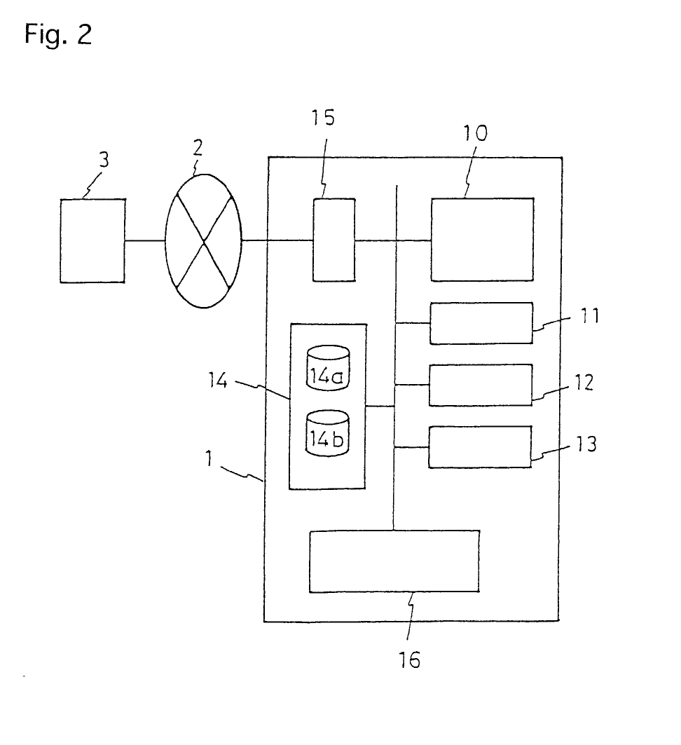

FIGS. 1 and 2 show a virtual exhibition system according to a preferred embodiment of the present invention. Here, numeral 1 is a virtual exhibition device; numeral 2 is the Internet; and numeral 3 is a user terminal, such as a personal computer.

In FIG. 1, Web servers A, B, C, . . . , Y and client terminals a1, a2, . . . y3, which serve as the user terminals 3, are connected to the virtual exhibition device 1 via the Internet 2.

Further, the virtual exhibition device 1 includes a Web server 10, a virtual exhibition server 11, a product-information-display server 12, a virtual-negotiating-room server 13, a database storage manager 14, a virtual-exhibition database 14a, a product-information database 14b, an Internet-communication-line connecting terminal 15, and a control terminal 16.

The Web server 10 controls the reception of data from users and the transmission of data to users. That is, data received from users is transferred via the Internet 2 to the virtual exhibition server 11, the product-information-display server 12, and the virtual-negotiating-room server 13, and data read from the virtual exhibition server 11, product-information-display server 12, and virtual-negotiating-room server 13 is transferred to users via the Internet 2.

The database storage manager 14 controls the virtual-exhibition database 14a and the product-information database 14b, and it updates the databases in the database storage manager 14 or reads data therefrom according to control signals transmitted from the virtual exhibition server 11 and the product-information-display server 12.

Next, the steps of the searching operation performed by this virtual exhibition system between the user terminal 3 and the virtual exhibition device 1 will be described.

The user operates a Web browser on a client terminal a1, which is a personal computer 3 as shown in FIGS. 1 and 2, to access the virtual exhibition device 1 from the provider's Web server A via the Internet 2. When the user connects to the virtual exhibition device 1, an initial Web page 30 (home page) is displayed on the display monitor of the user terminal 3. From the Web page 30, various Web pages can be selected, as described below.

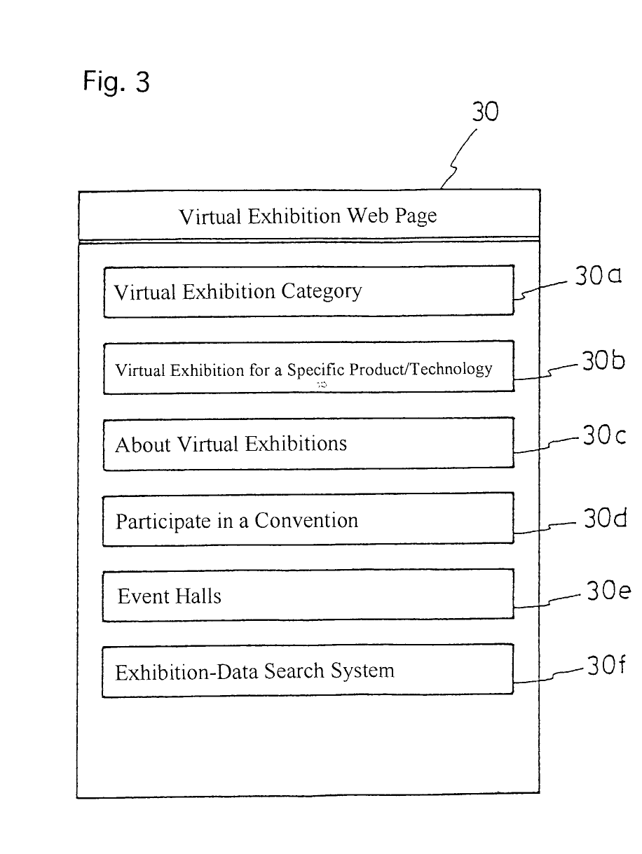

FIG. 3 shows menu items 30a-30f in the Web page 30 of the preferred embodiment. If the user wishes to view information about virtual exhibitions, the user can select an About Virtual Exhibitions button 30c to display (1) a Web page that explains the virtual exhibition site, (2) a schedule that indicates when virtual exhibitions will be held, (3) an introduction to the functions of said exhibitions, (4) news, (5) a reception desk for applying to hold an exhibition, and (6) other similar content.

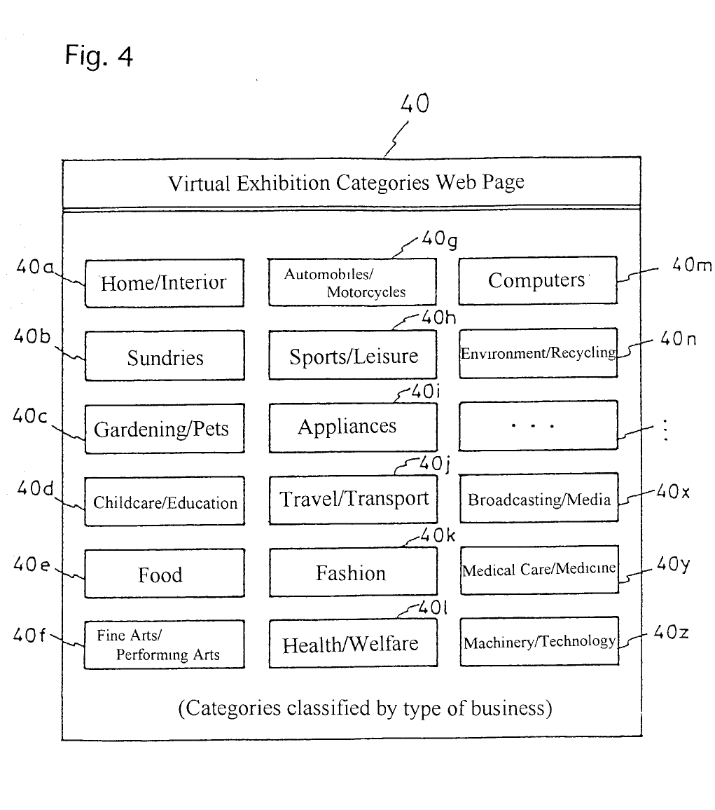

Users who are already familiar with using the virtual exhibition site can select a Virtual Exhibition Category button 30a. The Web server 10 in the virtual exhibition device 1 receives a signal for this selection, transfers the signal to the virtual exhibition server 11, and reads data from the virtual-exhibition database 14a. The Web server 10 then displays a Web page in response to the data read from the virtual-exhibition database 14a (virtual exhibiting means). FIG. 4 shows a screen image 40 of the present embodiment for the Web page displayed at this time. As shown in FIG. 4, the virtual-exhibition-categories Web page 40 is divided into categories 40a-40z for each type of business. The user can select any of these categories.

The categories should include at least the following: home/interior 40a, sundries 40b, gardening/pets 40c, childcare/education 40d, food 40e, fine arts/performing arts 40f, automobiles/motorcycles 40g, sports/leisure 40h, appliances 40i, travel/transport 40j, fashion 40k, health/welfare 401, computers 40m, environment/recycling 40n, broadcasting/media 40x, medical care/medicine 40y, and machinery/technology 40z.

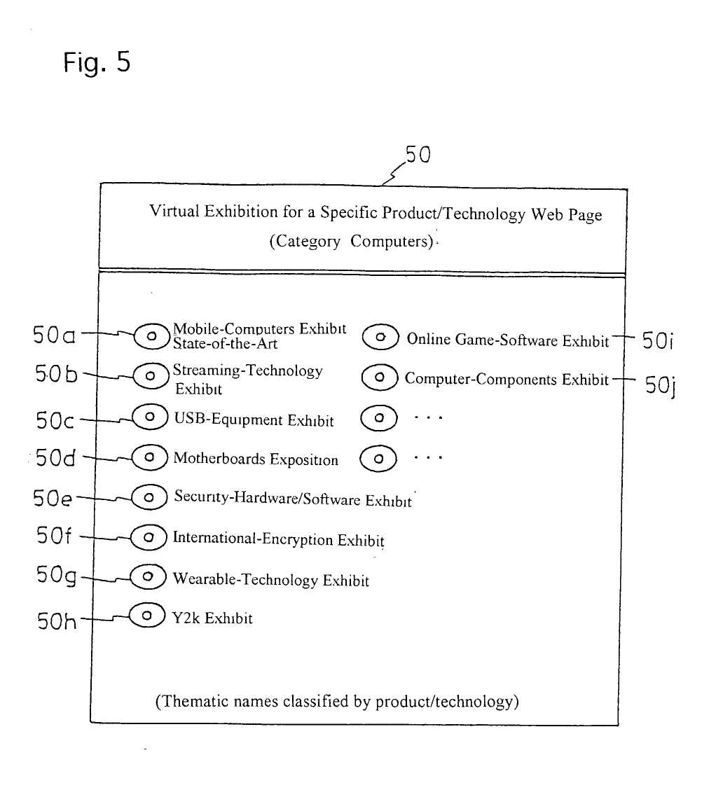

The user selects an item from the screen image 40. The Web server 10 receives a signal for this item, transfers the signal to the virtual exhibition server 11, and connects with the database storage manager 14 in order to display the Web page corresponding to the selection (virtual exhibiting means). FIG. 5 shows a Web page 50 that is displayed as a result.

FIG. 5 shows the Web page displayed when the category “Computers” is selected. Hence, by selecting a single category from among the various types of businesses, a group of virtual exhibition themes that fall within this category are displayed on the Web page 50.

In this case, at least the following themes 50a-50j are displayed as menu items in the Web page 50. The themes include a state-of-the-art mobile-computers exhibit 50a, a streaming-technology exhibit 50b, a USB-equipment exhibit 50c, a motherboards exposition 50d, a security-hardware/software exhibit 50e, an international-encryption exhibit 50f, a wearable-technology exhibit 50g, a Y2K exhibit 50h, an online game-software exhibit 50i, and a computer-components exhibit 50j.

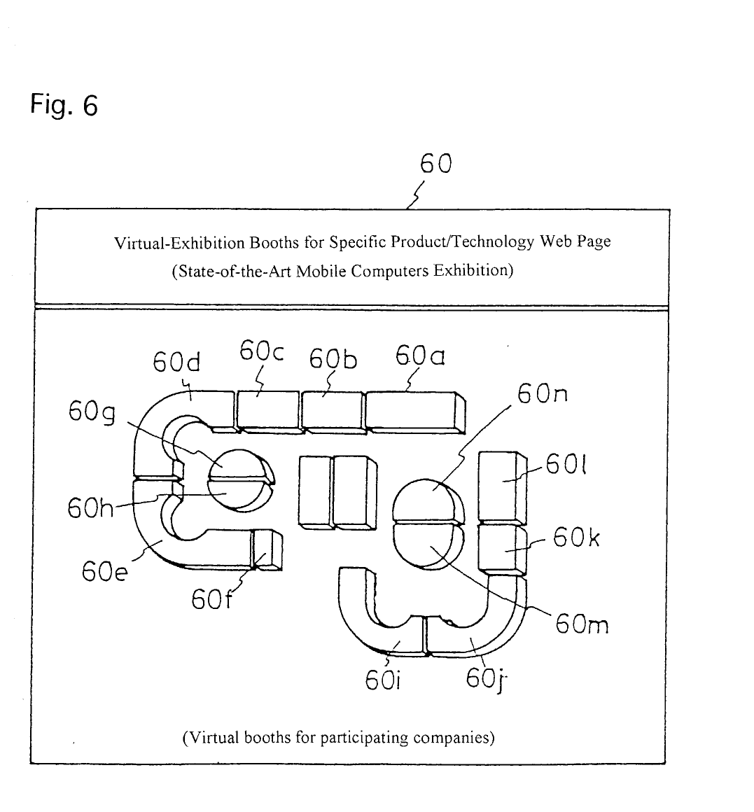

The user selects one of the items listed in the Web page 50. The Web server 10 receives a signal for this selection, transfers the signal to the virtual exhibition server 11, contacts the virtual-exhibition database 14a, and displays the Web page corresponding to the selection (virtual exhibiting means). FIG. 6 shows a Web page 60 displayed at this time.

As shown in FIG. 6, the Web page 60 displays virtual booths for specific products and technologies within the scope of the selected category. The example shown in FIG. 6 is displayed when the user selects the category “Computers” and the virtual exhibition theme “State-of-the-Art Mobile-Computers Exhibit.”

A group of booths in the virtual exhibition are displayed on the screen. In this example, virtual booths 60a-60n are displayed for companies participating in the exhibition.

By selecting one of the participating companies 60a-60n, the user can “visit” (i.e., select) the booth for that company so as to view a display of the company's specific products and to collect exhibit data. Because exhibit data is provided by each participating company and is edited in a uniform format, the user can easily compare and study data for various companies.

The virtual-exhibition database 14a is configured with files for each virtual-exhibition theme that is stored in a folder for each category name. Hence, the database is configured in a hierarchical structure that facilitates browsing. If the user wishes to collect more-detailed information about a specific product, the user opens a booth for a single participating company among the group of booths and selects a button requesting detailed information in a Web page. The Web server 10 receives a signal for this request, transfers the signal to the product-information-display server 12, contacts the product-information database 14b, and displays a Web page corresponding to the selection (product-information displaying means).

From this display, the user can collect a large volume of detailed data—including videos, color images, and the like—submitted by the participating company.

When the user wishes to negotiate for the possible purchase of a product, the user can select the “Negotiation Room” on a screen displayed after opening a booth for a particular company.

After receiving a signal for this request, the Web server 10 transfers the signal to the virtual-negotiating-room server 13. The virtual-negotiating-room server transfers the user's request to a representative of the participating company. After receiving this request, the representative sends to the user a conversation application with a built-in encryption key and logs into a private-conversation Web page at a prearranged date and time.

After receiving the reply from the representative, the user uses the conversation application to log into the private-conversation Web page at the preset date and time. If both the representative and user log into the conversation Web page at this time, the virtual-negotiating-room server 13 on the system end requests that each input a password. If the passwords are correct, the user and representative can begin negotiating on a private-conversation Web page 70.

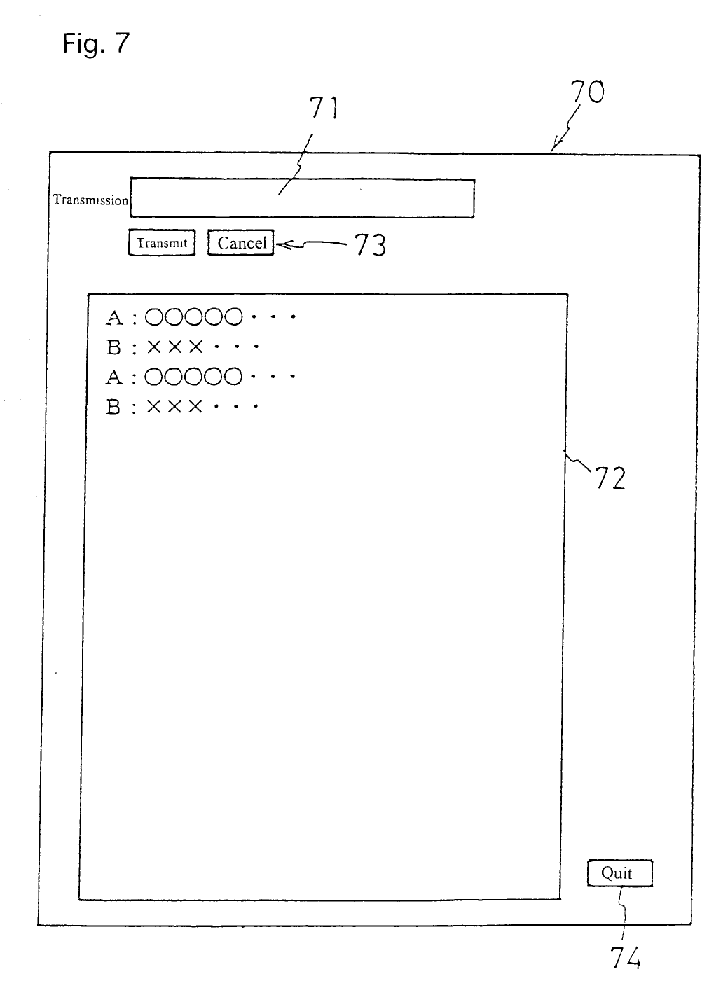

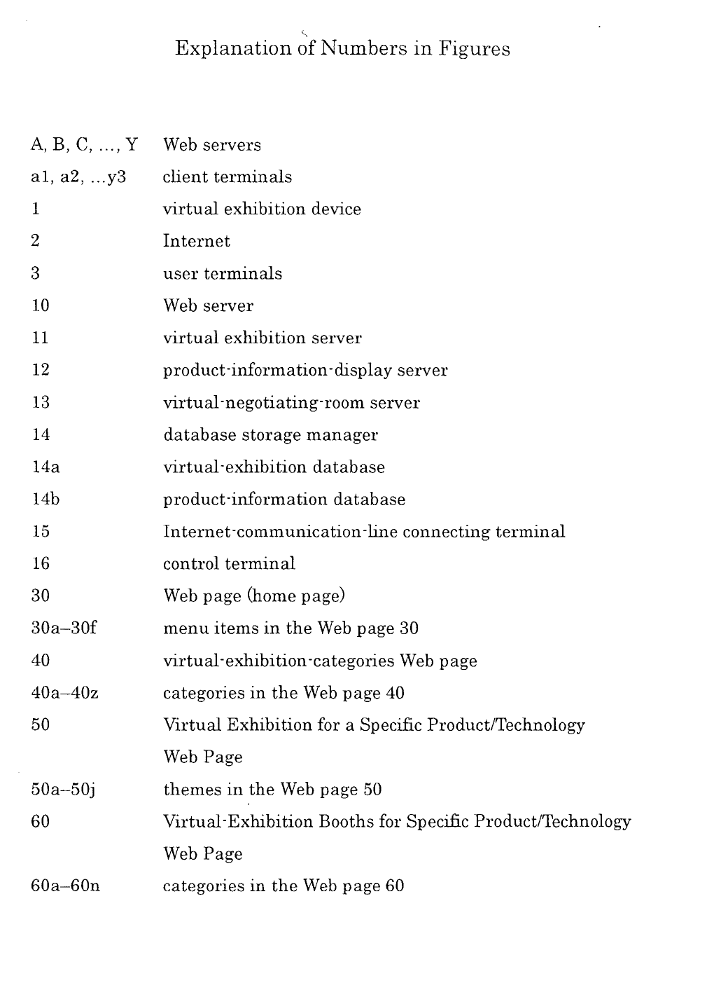

FIG. 7 shows the private-conversation Web page 70. The private-conversation Web page 70 includes a space 71 for inputting transmission content, a space 72 for displaying output of the conversation, transmission and cancel buttons 73 for transmitting or canceling transmission of the content in the space 71, and a “Quit” button 74 for terminating the conversation.

When the “Quit” button 74 has been selected to end the conversation, a signal transmitted from that button causes the virtual-negotiating-room server 13 to remove all data for the conversation and the log by automatically uninstalling the conversation application.

Accordingly, security for maintaining confidentiality of the conversation is increased by transmitting a single-use conversation application with a built-in encryption key for each conversation.

Here, we return to the Web page 30 shown in FIG. 3 to describe the remaining selection buttons. The numeral 30d indicates a selection button for “attending” a convention. When this button is selected a Web page is displayed, enabling the user to further select a virtual seminar or a virtual forum in which to participate. In these screens the user can participate in a workshop or an open forum, respectively.

By selecting an “Event Halls” button 30e in the Web page 30, a Web page is displayed for selecting a virtual hall for a drawing, a sales promotion, or the like. The user selects one of the halls in order to participate in the chosen event.

When selecting an “Exhibit-Information” search-system button 30f in the Web page 30, a Web page is displayed with the same searching method as a conventional Web page, enabling searches by the usual keywords, manufacturer's name, and the like.

### Industrial Applicability

The virtual exhibition system of the present invention has the following effects. The system is capable of transmitting Web pages for a virtual exhibition from a Web server to a user's personal computer that is connected to the Internet to be displayed on said personal computer and is capable of easily collecting product information through simple operations performed by the user. The user accesses the display on the user's personal computer and uses a database in which product information is presorted according to business type and further sorted into specific products for each company, enabling the user to “attend” a virtual exhibition held exclusively for a single specific product and then to compare the products of various company.

Further, exhibit data provided by companies participating in the exhibition is edited into a uniform format and stored in a database, thereby facilitating comparisons of different companies' products and the collection of product data from numerous companies.

Further, the present invention maintains confidentiality in business negotiations, enabling the user to conduct safe and easy negotiations from the user's personal computer.

1. (deleted)

2. (deleted)

3. (amended) a virtual exhibition system capable of transmitting, from a web server to a user terminal, such as a personal computer that connected to the internet, a web page for a virtual exhibition and displaying the web page on the user terminal, enabling the user to collect product information from the displayed web page, the system comprising:
a virtual-exhibition database provided with a folder for each of a plurality of categories denoting types of businesses used to classify data regarding exhibited products of companies entered in a virtual exhibition and for storing files with thematic names of the virtual exhibitions that denote a category of products or their technologies and that identify product types that further classify the exhibited product data in each category;
a product-information database for storing a large volume of product data, such as videos and images, released by companies for such exhibitions;
virtual exhibiting means for reading data from the virtual-exhibition database and displaying on the user's terminal a screen corresponding to a user's selection when the user selects either one of the categories or one of the thematic names of the virtual exhibitions from the Web page, for displaying virtual-exhibition booths of companies that entered products under the thematic name selected by the user, and for displaying exhibit data edited in a uniform format for a company selected by the user;
product-information displaying means for reading data from the product-information database and displaying a screen of product information, including video and images, when the user requests more-detailed information for a product after selecting a booth in the virtual exhibition; and
virtual-negotiation-room means for enabling the user and a representative of a company participating in the exhibition to conduct a highly confidential discussion over an Internet communication line about a product exhibited by the company when the user “visits” (i.e., selects) the company's booth in the virtual exhibition and selects “Negotiation Room” from the screen displayed on the user's terminal,
wherein the virtual-negotiation-room means (1) transmits a negotiation request to a representative of the company on the Web page when the user selects “Negotiation Room” (2) allows negotiations to commence between the user and representative after the representative sends to the user a single-use conversation application with built-in encryption key and logs into a private-conversation Web page at a preset date and time and the user receives the reply from the representative and also logs into the private-conversation Web page at the preset date and time using the conversation application, (3) provides both the representative and the user input-correct passwords to be input when the system prompts for password input; and (4) automatically deletes the conversation application and all related data, such as the conversation and log data, from the system after receiving a signal indicating the conversation has ended.

4. (amended) A virtual exhibition system as recited in claim 3, wherein the user can participate in a workshop, an open forum, or the like in a Web page displayed when the user first selects “Participate in a Convention” in the initial Web page displayed on the user's terminal and then selects either “Virtual Seminar” or “Virtual Forum.”

5. (amended) A virtual exhibition system as recited in claim 3 or claim 4, wherein the user can participate via a Web page in a virtual hall involving a drawing or sales promotion by first selecting “Event Halls” in the initial Web page displayed on the user's terminal and then selecting a hall.
